(19) United States
(12) Patent Application Publication
(10) Pub. No.: US 2023/0296482 A1
(43) Pub. Date: Sep. 21, 2023

(54) AUTOMATED AEROSOL SAMPLER

(71) Applicant: INTERNATIONAL BUSINESS MACHINES CORPORATION, ARMONK, NY (US)

(72) Inventors: Vincent MORIARTY, Queensbury, NY (US); Michael Robert Kelly, Albany, NY (US)

(21) Appl. No.: 17/655,558

(22) Filed: Mar. 21, 2022

(51) Int. Cl. G01N 1/22; G01N 35/10; G01F 23/00

(52) U.S. Cl. CPC G01N 1/2273; G01N 35/1009; G01F 23/0007; G01N 2001/2297; G01N 2001/2223

(57) ABSTRACT

According to one embodiment, a method, computer system, and computer program product for collecting aerosol samples is provided. The present invention may include, responsive to one or more sample collection criteria being met, collecting an aerosol sample in at least one of one or more collection media including at least one liquid collection medium, wherein collecting the aerosol sample comprises propelling air, via an air pump, through a collection medium of the one or more collection media for a duration equal to a sample integration time; responsive to detecting that a sampler liquid level in at least one liquid collection medium is below a threshold, raising the sampler liquid level in the at least one liquid collection medium to meet the threshold; and transmitting a message alerting one or more users that the aerosol sample has been collected.

### STATEMENT REGARDING PRIOR DISCLOSURES BY THE INVENTOR OR A JOINT INVENTOR

The following disclosure(s) are submitted under 35 U.S.C. 102(b)(1)(A): DISCLOSURE(S): “The detection of airborne anatoxin-a (ATX) on glass fiber filters during a harmful algal bloom”, [Sutherland J W, Turcotte R J, Molden E, Moriarty V, Kelly M, Aubel M, Foss A.], Published Apr. 1, 2021, Pages 113-119, Retrieved from the Internet: <URL: https://www.tandfonline.com/doi/abs/10.1080/10402381.2021.1881191?journalCode=ulrm20>.

### BACKGROUND

The present invention relates, generally, to the field of computing, and more particularly to aerosolized particle collection.

An aerosol is defined as a suspension system comprising solid or liquid particles in a gas, which is usually air. Types of aerosol may include dust, fumes, mist, smoke, and fog. Some aerosolized particles may include harmful toxins, such as those produced by cyanobacteria, and unlike the previous examples, may be difficult to detect and harder to identify. Aerosolized particle detection is the practice of identifying the presence of such aerosols in the environment, which has applications in industrial hygiene through workplace air quality monitoring, and medical health and safety by monitoring for airborne viruses, bacteria, and toxins. However, aerosolized particle detection is impossible unless samples of the aerosolized particle can be collected. Accordingly, the efficacy of any aerosolized particle detection method, and the benefit such a method stands to realize, is inextricably linked to the quality of the sample, and by extension to the efficacy of aerosolized particle collection methods.

### SUMMARY

According to one embodiment, a method, computer system, and computer program product for collecting aerosol samples is provided. The present invention may include, responsive to one or more sample collection criteria being met, collecting an aerosol sample in at least one of one or more collection media including at least one liquid collection medium, wherein collecting the aerosol sample comprises propelling air, via an air pump, through a collection medium of the one or more collection media for a duration equal to a sample integration time; responsive to detecting that a sampler liquid level in at least one liquid collection medium is below a threshold, raising the sampler liquid level in the at least one liquid collection medium to meet the threshold; and transmitting a message alerting one or more users that the aerosol sample has been collected.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an exemplary aerosol sampling system according to at least one embodiment;

FIG. 3 illustrates an exemplary aerosol sampling system according to at least one embodiment;

FIG. 4 illustrates an exemplary aerosol sampling system according to at least one embodiment;

FIG. 5 illustrates an exemplary aerosol sampling system according to at least one embodiment;

FIG. 6 illustrates an exemplary aerosol sampling system according to at least one embodiment;

FIG. 7 illustrates an exemplary aerosol sampling system according to at least one embodiment;

FIG. 8 is an operational flowchart illustrating an aerosol sampler process according to at least one embodiment;

FIG. 9 is a block diagram of internal and external components of computers and servers depicted in FIG. 1 according to at least one embodiment;

FIG. 10 depicts a cloud computing environment according to an embodiment of the present invention; and

FIG. 11 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to aerosolized particle collection. The following described exemplary embodiments provide a system, method, and program product to, among other things, collect and store aerosol samples for future analysis over a long period based on onboard decision-making using real-time sensor data. Therefore, the present embodiment has the capacity to improve the technical field of aerosolized particle collection by providing a system capable of extended field deployments required for detection of trace aerosolized toxins.

As previously described, an aerosol is defined as a suspension system comprising solid or liquid particles in a gas, which is usually air. Types of aerosol may include dust, fumes, mist, smoke, and fog. Some aerosolized particles may include harmful toxins, such as those produced by cyanobacteria, and unlike the previous examples, may be difficult to detect and harder to identify. Aerosolized particle detection is the practice of identifying the presence of such aerosols in the environment, which has applications in industrial hygiene through workplace air quality monitoring, and medical health and safety by monitoring for airborne viruses, bacteria, and toxins. However, aerosolized particle detection is impossible unless samples of the aerosolized particle can be collected. Accordingly, the efficacy of any aerosolized particle detection method, and the benefit such a method stands to realize, is inextricably linked to the quality of the sample, and by extension to the efficacy of aerosolized particle collection methods.

One area where aerosolized particle detection stands to make a significant impact is in the detection of cyanotoxins. Harmful Algal Blooms (HABs) occur when colonies of algae reproduce at an accelerated rate and produce harmful effects on people and aquatic environments. HABs occur in both marine and freshwater environment, and depending on the species involved in the bloom, are capable of producing toxins that can pose risks to human and animal health. While the effects of direct contact and ingestion of cyanotoxins have been well documented, indirect exposure to cyanotoxins via inhalation of aerosolized toxins has only recently been evaluated as a cause of concern and poses a potentially serious human health risk. Most direct contact and ingestion of cyanotoxins can easily be averted by avoiding contact with a body of water. However, the threat of aerosolized toxins can affect not only shoreline areas but can be carried for long distances depending on local wind patterns. Successful detection of these toxins enables avoidance and remediation measures that can mitigate or prevent harmful effects to both people and the environment, potentially saving lives.

Low density aerosolized particles can be difficult to detect with traditional environmental hygiene sampling protocols, yet chronic exposure to low-level toxic or otherwise harmful aerosolizes can lead to major human health challenges. Detection and quantification of aerosolized toxins usually requires expensive, high volume sampling equipment ill-suited for remote locations, which may be limited to a single collection method and/or may only be suitable for laboratory use. Available liquid-based collectors are limited to short duration due to loss of sampler liquid from evaporation. As such, it may be advantageous to, among other things, implement a system that is environmentally hardened to withstand deployment in a variety of challenging remote environments, without need for line voltage; it may further be advantageous to implement a system which, through remote deployments, efficient particle capture, long integrated sampling periods, intelligent endpoint design, and automated sampling fluid monitoring and adjustment, is capable of collecting aerosol samples of sufficient density as to be measurable by appropriate on-site laboratory analysis.

According to at least one embodiment, the invention is an aerosol sample collection system comprising a control unit and a sample collector.

According to at least one embodiment of the invention, the control unit may comprise a computing device, a battery, an air pump, a rotameter, and at least one environmental sensor disposed within an environmentally hardened casing. The environmentally hardened casing may be durable enough to withstand minor impacts and may be waterproof.

The air pump may be any device that moves air by mechanical action, such as a vacuum pump. The air pump is connected to the collection medium by an air conduit. The vacuum pump may draw air from the environment into and through the sample collection medium of the sample collector, drawing aerosol particles from the environment into the sample collection medium for collection. In some embodiments of the invention, the air pump may draw the environmental air through the air pump and back into the environment through an exhaust port built into the casing of the control unit. In some embodiments of the invention, a water trap and/or a rotameter may be connected to the tube between the air pump and the collection medium, such that the air flows through them. The water trap may serve to draw out moisture from the environmental air into a reservoir or out an exhaust so as to reduce the amount of moisture being drawn through the air pump. The rotameter may be a device that enlarges or constricts the cross-sectional area of a fluid conduit to control flow of fluid through the fluid conduit. The rotameter may comprise a sensor that measures the volumetric rate of flow of fluid through the fluid conduits.

The fluid conduits, as referred to herein, may be any enclosed channel for conveying fluids between components of the system, such as rubber or plastic tubes or piping. A fluid conduit may comprise either a conduit for conveying air, herein referred to as an air conduit, or a conduit for conveying sampler liquid, herein referred to as a liquid conduit. Air conduits are primarily intended herein to convey atmospheric air, but, as one skilled in the art would understand, atmospheric air comprises varying amounts of liquid, namely water, so air conduits may not be limited to the conveyance of air. In some embodiments of the invention, a fluid conduit may comprise a combined conduit, which may in turn comprise both an air conduit and a liquid conduit, wherein the liquid conduit is a smaller diameter conduit than the air conduit, such that the liquid conduit may run within the air conduit leaving enough cross-sectional area in the air conduit to convey air. In some embodiments, the liquid and air conduits may be reversed in position, such that the air conduit lays within the liquid conduit. The purpose of this consolidation may be to reduce the total number of fluid conduits, thereby simplifying the system for the user. In embodiments where both a liquid conduit and air conduit are connecting to the same collection vessel, one skilled in the art would understand that the two conduits may be consolidated into a combined fluid conduit in the manner described above.

The environmental sensor may be any sensor enabled to measure a characteristic of the environment within which the system is deployed. For example, the environmental sensor may measure the temperature, humidity, air quality, amount of sunlight, et cetera. The environmental sensor may be modular and may correspond to a sample collection criteria; for example, if a user requires samples to be taken whenever humidity exceeds a threshold, the humidity sensor may be connected to the control unit. In some embodiments of the invention, the humidity sensor may be disposed within the casing of the control unit, may be mounted externally, may be mounted to the sample collector, and/or may be a separate device that is capable of communicating with the control unit through either a wired or wireless connection.

In some embodiments, for example where the system is designed for long deployments, the system may comprise a solar cell electrically connected to the battery of the control unit, which may be mounted to the control unit or may be electronically linked to the battery of the control unit. In some embodiments of the invention, the system and/or client computing device may comprise a radio or cellular modem, ethernet connection, or other device to enable communication over distances, such that the system may wirelessly communicate with remote users or software elements even when deployed in remote locations.

According to at least one embodiment of the invention, the sample collector may comprise one or more sample collection vessels, and may be connected to the control unit through one or more fluid conduits. In some embodiments of the invention, for example where the sample collector comprises one or more liquid collection vessels, the sample collector may further comprise a sun-shade to, for example, shield the collection vessels from the sun and prevent evaporation of sampler liquid and deterioration of sensitive sample material due to exposure to solar (ultraviolet) radiation. The shade may also restrict direct atmospheric contamination and offer some protection from the environment. In some embodiments of the invention, the sample collection vessels may be attached to a vertical structural member which rests on three or more legs for stabilization; a sun-shade may be attached to the structural member above the sample collection vessels.

In some embodiments of the invention, the sample collection vessels, also referred to herein as sample collection media, may be any device designed to collect aerosolized particles from environmental air that is drawn through them. In some embodiments of the invention, the sample collection vessels may be capable of collecting and storing a single sample apiece. The sample collection vessels may comprise solid collection vessels which trap or isolate particles in the air through the use of, for example, filters, impingers, or impactors. The sample collection vessels may comprise liquid collection vessels, which collect particles by bubbling environmental air through a liquid that binds to the particulates; that liquid is herein referred to as sampler liquid. The sample collection vessels may comprise any number or combination of sample collection devices, liquid, solid, or otherwise.

In some embodiments of the invention, for example where the sample collector comprises a plurality of collection vessels, the system may comprise an air multiplexing manifold attached to the one or more air conduits between the air pump and the plurality of collection vessels, where the air multiplexing manifold controls airflow from the air pump to the plurality of collection vessels. The air multiplexing manifold may be connected by a single air conduit to the air pump and may split the air conduit into as many conduits as sample collection vessels, such that each sample collection vessel is connected to the air multiplexing manifold via an air conduit. The air multiplexing manifold may comprise one or more valves and/or a solenoid, or may employ any other means of controlling airflow, and may be electrically connected to the control unit such that the airflow can be controlled by the client computing device. In this way, the system may select a collection vessel from multiple available collection vessels to take a sample with and may use the air multiplexing manifold to route airflow through the selected collection vessel to take a sample. The addition of the air multiplexing manifold along with multiple sample collection vessels allows for multiple samples to be taken at different times and under different sample collection criteria, improving the quantity of time-series samples available per deployment and allowing collection of samples under different conditions, improving the quality of the data yielded by the samples.

In some embodiments, for example where the sample collector is equipped with a liquid collection medium, the control unit may further comprise a sampler liquid pump and a sampler liquid reservoir and may be capable of pumping sampler liquid from the sampler liquid reservoir into the liquid collection medium of the sample collector via the liquid conduits. The sampler liquid reservoir may hold sampler liquid to be pumped into the liquid collection vessels. The liquid collection medium itself may be equipped with a sensor for measuring the level of sampler liquid within the liquid collection medium, such as a contactless ultrasonic, optical, or capacitive liquid level sensor. Sampler liquid loss is a limiting factor for liquid-based sample collection media, such as liquid impaction type samplers, as the efficiency of the collection medium is greatly reduced when the level of sampler liquid drops below a threshold level. Continuous maintenance of sampler liquid levels within the liquid collection medium is vital to counteract sampler liquid loss through, for example, evaporation, and maintain the efficiency of the liquid collection vessel.

In some embodiments of the invention, for example where a plurality of sample collection vessels comprise a plurality of liquid collection media, the system may comprise a second multiplexing manifold, herein referred to as a liquid multiplexing manifold. The liquid multiplexing manifold may be connected to the one or more liquid conduits between the liquid pump and the plurality of liquid collection vessels, where the liquid multiplexing manifold controls liquid flow from the liquid pump to the plurality of liquid collection vessels. The liquid multiplexing manifold may be connected by a single liquid conduit to the liquid pump and may split the liquid conduit into as many conduits as liquid sample collection vessels, such that each liquid sample collection vessel is connected to the liquid multiplexing manifold via a liquid conduit. The addition of the liquid multiplexing manifold along with multiple liquid sample collection vessels allows the system to maintain the sampler liquid levels of several liquid collection vessels, allowing them to continue to function efficiently over a significant period of time.

In some embodiments of the invention, for example where a plurality of sample collection vessels comprise a plurality of liquid collection media, the system may comprise a dual-purpose multiplexing manifold for routing both airflow and sampler liquid flow into the collection vessels, herein referred to as a combined multiplexing manifold. The combined multiplexing manifold may be attached to the one or more liquid conduits between the liquid pump and the plurality of liquid collection vessels, where the combined multiplexing manifold controls liquid flow from the liquid pump to the plurality of liquid collection vessels. The combined multiplexing manifold may be connected by a single liquid conduit to the liquid pump and may split the liquid conduit into as many conduits as liquid sample collection vessels, such that each liquid sample collection vessel is connected to the combined multiplexing manifold via a liquid conduit. The combined multiplexing manifold may additionally be connected by a single air conduit to the air pump and may split the air conduit into as many conduits as sample collection vessels, such that each sample collection vessel is connected to the multiplexing manifold via an air conduit. The combined multiplexing manifold may comprise one or more valves and/or a solenoid or may employ any other means of controlling airflow and liquid flow, and may be electrically connected to the control unit such that the airflow and fluid flow can be controlled by the client computing device. In this way, the system may select a collection vessel from multiple available collection vessels to take a sample with and may use the multiplexing manifold to route airflow or fluid flow through or into the selected collection vessel to either take a sample or fill up the sampler liquid of a liquid collection vessel, reducing the number of multiplexing manifolds required and keeping the system streamlined and simple. In some embodiments of the invention, the combined multiplexing manifold may be connected to liquid collection vessels by combined conduits.

As referred to herein, a multiplexing manifold may comprise an air multiplexing manifold, a liquid multiplexing manifold, or a combined multiplexing manifold.

According to at least one embodiment, the invention is a method of collecting aerosol samples with an aerosol sample collection system. The method may include checking to determine if sample collection criteria have been met, and if sample collection criteria have been met, turning on the air pump for a duration of time corresponding to a sample integration time. Once the sample integration time has elapsed, the system may send a message to alert personnel to retrieve the collected sample.

According to at least one embodiment, for example where the system comprises at least one liquid collection medium, the invention is a method of collecting aerosol samples with an aerosol sample collection system. The method may include checking to determine if sample collection criteria have been met, and if sample collection criteria have been met, checking to determine if sampler liquid meets or exceeds a threshold level within the liquid collection medium. If the sampler liquid is below the threshold level, the system may engage the fluid pump until the sampler liquid is at or above the threshold level. If the sampler liquid is at or above the threshold level, the system may turn on the air pump for a duration of time corresponding to a sample integration time. Once the sample integration time has elapsed, the system may send a message to alert personnel to retrieve the collected sample.

In some embodiments of the invention, rather than run the air pump for a duration of time corresponding to a sample integration time, the system may run the air pump for a sub-integration duration of time, for example 15 minutes; after the sub-integration duration of time has elapsed, the system may check to determine if the sample integration time has elapsed. If the sample integration time has not elapsed, the system may check to determine if the sampler liquid is at or above the threshold level. If the sampler liquid is not at or above the threshold level, the system may pause the air pump and engage the fluid pump until the quantity of sampler liquid has reached or exceeded the threshold level. If the sampler liquid is at or above the threshold level, the system may trigger the air pump for the sub-integration duration. In situations where the sample integration time is long, evaporation of sampler liquid may occur while the sample is being taken. As such, the system may check sampler liquid levels in an increment of time that is shorter than the sample integration time (sub-integration duration) to allow the system to top off the sampler liquid and maintain the efficiency of the sample collectors even in the event of long sample integration times. Since sample integration times are longer the more difficult an aerosolized particle is to detect, this measure improves the chances of achieving a sample density sufficient for reliable detection while using liquid collection vessels to detect more elusive aerosolized particles. In some embodiments of the invention, for example where the system comprises multiple liquid collection vessels, the system may check the sampler liquid levels of each liquid collection vessel and engage the liquid pump as necessary to ensure all liquid collection vessels are at or above the threshold level before re-engaging the air pump.

In some embodiments of the invention, the system may calculate, at regular intervals and/or responsive to changes in the data, an evaporation rate for the sampler liquid currently and/or at different times of day based on remote data and/or data from the environmental sensors and/or an internal clock/calendar, such as time of day, time of year, temperature, whether the system is in direct sunlight, et cetera. The sub-integration duration may be dynamically adjusted based on the evaporation rate at regular intervals, such as every hour or every minute, and/or may be adjusted at regular times of day and/or in real time based on changes in data as it is collected. The sub-integration duration may be adjusted to represent, for example, a duration of time where minor evaporation has occurred but not enough to decrease the efficiency of a liquid collection vessel below a predetermined threshold efficiency.

In some embodiments of the invention, the sample collection criteria may be the conditions which, if met, trigger collection of a sample. Each sample collection vessel of the sample collector may be associated with sample collection criteria that governs the collection of the sample of that sample collection vessel. The sample collection criteria may include receipt of a command to trigger collection of a sample, for example entered by a human operator or external program. The sample collection criteria may be met according to a pre-programmed routine, which may, for example, trigger sample collection of a sample at a certain time of day. The sample collection criteria may comprise an environmental condition, as measured by an environmental sensor connected to the control unit, meeting or exceeding a threshold. For example, the sample collection criteria may be met when an environmental sensor measures a temperature that exceeds a threshold amount. In some embodiments of the invention, the sample collection criteria may comprise an environmental condition which is not measured by an environmental sensor connected to the system, but is rather checked against data, such as local weather data or weather model, that is crawled or received by the system from a remote source such as a database, the internet, environmental sensors of other systems including deployed sample collection systems, et cetera. In some embodiments of the invention, sample collection criteria for a given sample collection vessel may comprise any number or combination of conditions, all or some combination of which must be met to trigger collection of a sample in that sample collection vessel.

In some embodiments of the invention, the sample integration time may represent the amount of time the air pump must be run in order to achieve a sample of sufficient density as to be measurable by appropriate on-site laboratory analysis. Aerosolized particles can be difficult to detect because there are too few particles dispersed in the immediate atmosphere, and not enough particles can be captured in sample collection devices to allow detection of the particles. As such, for any given aerosolized particle, enough air must be run through the sample collection media to allow capture of enough particles that specialized devices could reliably detect the particles. In other words, the sample density must be high enough to allow reliable detection of the particles within the sample. Consequently, a volume of air corresponding to the dispersion of particles within the air and number of particles necessary for reliable detection must pass through the sample collection media. The sample integration time may accordingly be predetermined based on the characteristics of the aerosolized particle that the system is deployed to collect samples of, as well as the characteristics of the sample collection system, such as volume and flow rate of the air pump and air conduits, maximum air flow as dictated by sampling collection device, et cetera. In some embodiments of the invention, the sample integration time may additionally be dynamically adjusted based on airflow data gathered by the air flow sensor, for example in case the actual flow rate achieved by the sample collection system deviates from the expected flow rate, for example in the event that the air pump is malfunctioning and not achieving the flow rate it was designed for, and/or there is a kink or stoppage in the air conduits interfering with airflow, et cetera. In some embodiments of the invention, if the air flow sensor registers airflow below a threshold level of airflow, and/or if the airflow reported by the air flow sensor would result in a sample integration time that exceeds a threshold length, the system may operate the rotameter to increase airflow until the sample integration time meets or falls below the threshold length. In some embodiments, for example where the system cannot increase airflow enough through operation of the air pump and/or rotameter to bring the sample integration time to or below the threshold length, the system may terminate sample collection. In some embodiments of the invention, the system may subsequently alert a user to a potential malfunction of the sample collection system.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to collect and store aerosol samples for future analysis over a long period based on onboard decision-making using real-time sensor data.

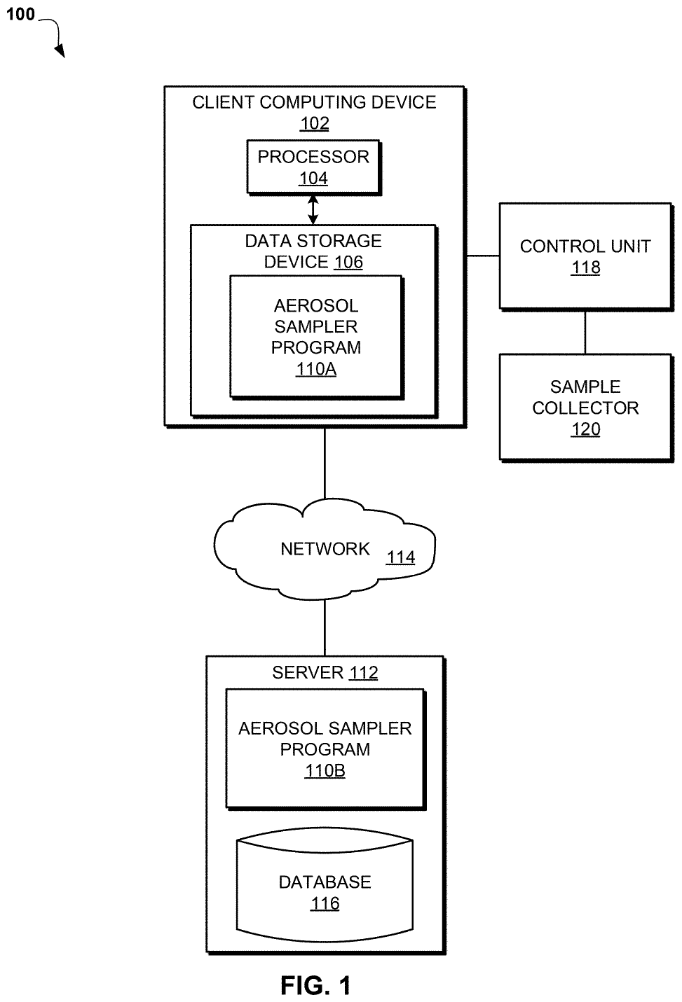

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

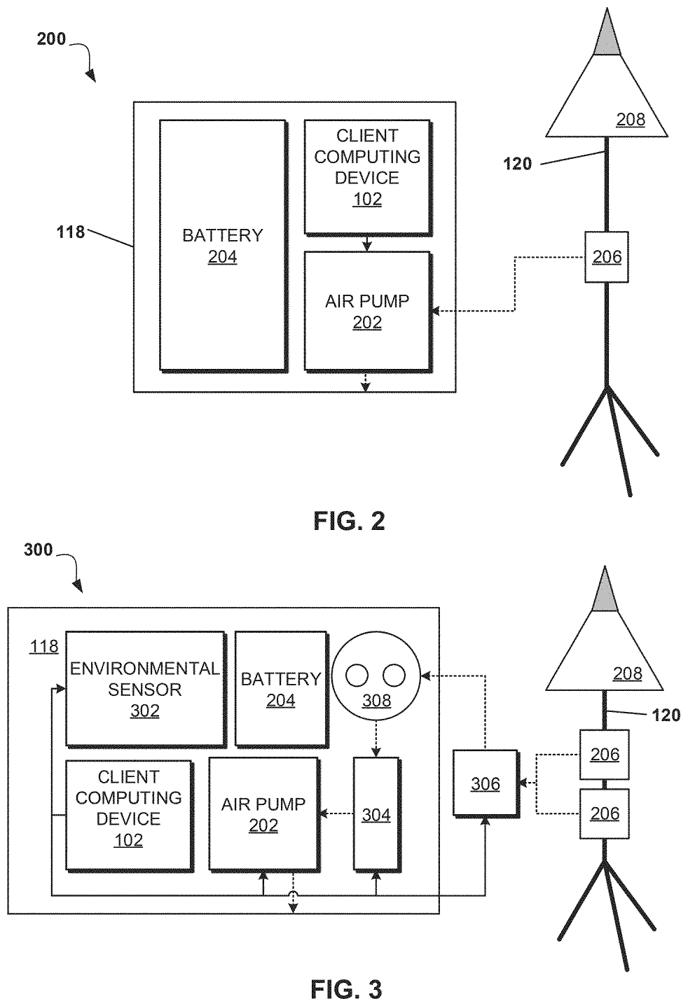

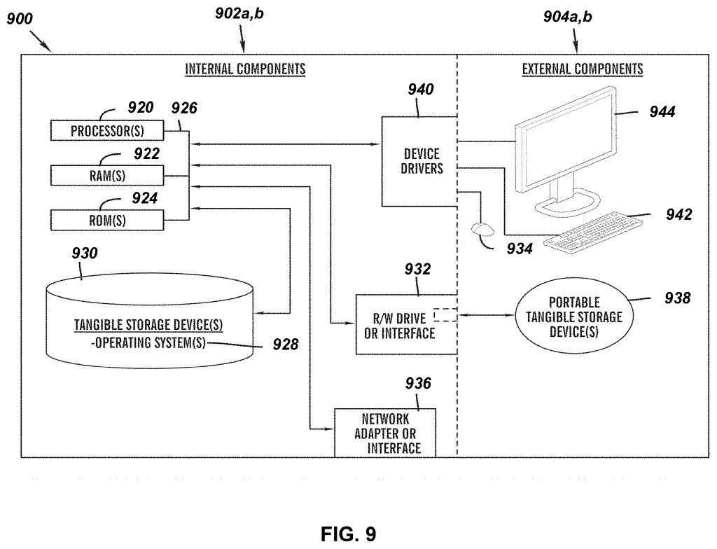

Client computing device 102 may include a processor 104 and a data storage device 106 that is enabled to host and run an aerosol sampler program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, a microcontroller, or any type of computing device capable of running a program and accessing a network. As will be discussed with reference to FIG. 9, the client computing device 102 may include internal components 902a and external components 904a, respectively. Client computing device may be operatively connected to and/or in communication with a control unit 118 which in turn may be operatively connected to and/or in communication with sample collector 120. Control unit 118 and sample collector 120 are explained in further detail below with respect to FIGS. 2-6.

The server computer 112 may be a laptop computer, netbook computer, personal computer (PC), a desktop computer, or any programmable electronic device or any network of programmable electronic devices capable of hosting and running an aerosol sampler program 110B and a database 116 and communicating with the client computing device 102 via the communication network 114, in accordance with embodiments of the invention. As will be discussed with reference to FIG. 9, the server computer 112 may include internal components 902b and external components 904b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

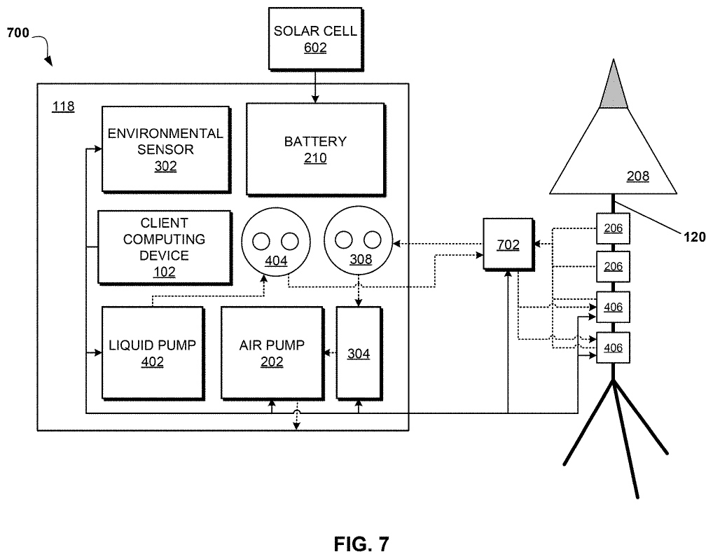

According to the present embodiment, the aerosol sampler program 110A, 110B may be a program enabled to collect and store aerosol samples for future analysis over a long period based on onboard decision-making using real-time sensor data. The aerosol sampler program 110A, 110B may be located on client computing device 102 or server 112 or on any other device located within network 114. Furthermore, aerosol sampler program 110A, 110B may be distributed in its operation over multiple devices, such as client computing device 102 and server 112. The aerosol sampler method is explained in further detail below with respect to FIG. 7.

Referring now to FIG. 2, an exemplary aerosol sampling system 200 is depicted according to at least one embodiment. Here, control unit 118 comprises a client computing device 102 which is electrically and operatively connected to an air pump 202 such that the client computing device 102 may control the air pump 202. The client computing device 102 and connected components may be connected to and powered by a battery 204. The sample collector 120 may comprise a solid collection vessel 206 sun-shade 208 which may serve to protect the solid collection vessel 206 from exposure to sun and rain. The air pump 202 may be connected to a solid collection vessel 206 via an air conduit, by means of which the air pump 206 may draw air from the environment into and through the sample collection vessel 206 so as to build up a critical density of aerosolized particles within the sample collection vessel 206. The air pump 202 may vent environmental air through an exhaust in the casing of control unit 118.

Referring now to FIG. 3, an exemplary aerosol sampling system 300 is depicted according to at least one embodiment. Here, control unit 118 comprises a client computing device 102 which is electrically and operatively connected to an air pump 202, environmental sensor 302, rotameter 304, and multiplexing manifold 306, such that the client computing device can control and/or receive sensor data from the connected components. The client computing device 102 and connected components may be connected to and powered by a battery 204. The sample collector 120 may comprise two solid collection vessels 206 and a sun-shade 208 which may serve to protect the solid collection vessels 206 from sun and rain. The air pump 202 may be connected to a solid collection vessel 206 via an air conduit, by means of which the air pump 202 may draw air from the environment into and through one of the solid collection vessels 206 at a time so as to build up a critical density of aerosolized particles within the solid collection vessel 206. Attached to the air conduit connecting the solid collection vessels 206 and air pump 202 are at least three components comprising a rotameter 304, a water trap 308, and a multiplexing manifold 306. The multiplexing manifold 306 may bifurcate the single air conduit from air pump 202 into two air conduits, one for each of the solid collection vessels 206. The multiplexing manifold 306 may operate to route airflow through one solid collection vessel 206 or the other, responsive to commands from client computing device 102. The air pump 202 may vent environmental air through an exhaust in the casing of control unit 118. The environmental sensor 302 may be any number of sensors designed to sense environmental conditions.

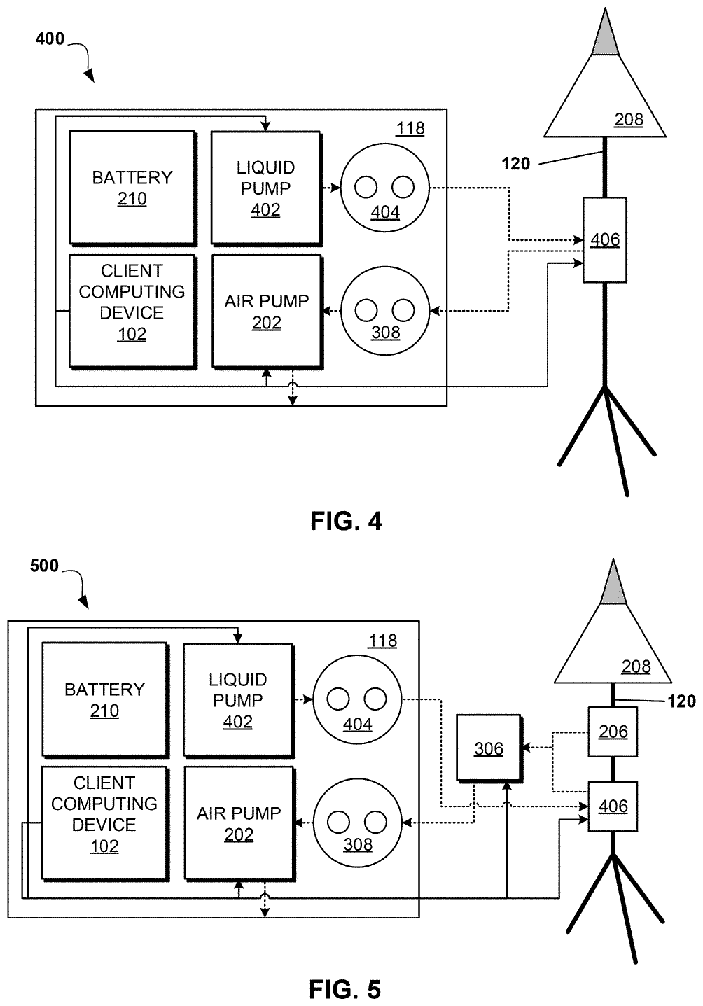

Referring now to FIG. 4, an exemplary aerosol sampling system 400 is depicted according to at least one embodiment. Here, control unit 118 comprises a client computing device 102 which is electrically and operatively connected to an air pump 202, a liquid pump 402, and a sampler liquid level sensor within liquid collection vessel 406, such that the client computing device can control and/or receive sensor data from the connected components. The client computing device 102 and connected components may be connected to and powered by a battery 204. The sample collector 120 may comprise a liquid collection vessel 406 and a sun-shade 208 which may serve to protect the liquid collection vessel 406 from rain and from evaporation of sampler liquid by the sun and heat. The liquid pump 402 may be connected to a sampler liquid reservoir 404, which may be connected to liquid collection vessel 406. The liquid pump 402 may operate to pump sampler liquid from sampler liquid reservoir 404 through a liquid conduit into liquid collection vessel 406, responsive to commands from client computing device 102. The air pump 202 may be connected to the liquid collection vessel 406 via an air conduit, by means of which the air pump 202 may draw air from the environment into and through the liquid collection vessel 406 so as to build up a critical density of aerosolized particles within the liquid collection vessel 406. Attached to the air conduit connecting the liquid collection vessel 406 and air pump 202 is a water trap 308.

Referring now to FIG. 5, an exemplary aerosol sampling system 500 is depicted according to at least one embodiment. Here, control unit 118 comprises a client computing device 102 which is electrically and operatively connected to an air pump 202, a liquid pump 402, and a sampler liquid level sensor within liquid collection vessel 406, such that the client computing device can control and/or receive sensor data from the connected components. The client computing device 102 and connected components may be connected to and powered by a battery 204. The sample collector 120 may comprise a solid collection vessel 206, a liquid collection vessel 406 and a sun-shade 208 which may serve to protect the liquid collection vessel 406 from rain and from evaporation of sampler liquid by the sun and heat. The liquid pump 402 may be connected to a sampler liquid reservoir 404, which may be connected to liquid collection vessel 406. The liquid pump 402 may operate to pump sampler liquid from sampler liquid reservoir 404 through a liquid conduit into liquid collection vessel 406, responsive to commands from client computing device 102. The air pump 202 may be connected to the solid collection vessel 206 and the liquid collection vessel 406 via air conduits and the multiplexing manifold 306, through which the air pump 202 may draw air from the environment into and through the solid collection vessel 206 or the liquid collection vessel 406 so as to build up a critical density of aerosolized particles within the selected collection vessel. Attached to the air conduit connecting the liquid collection vessel 406 and air pump 202 is a water trap 308. The multiplexing manifold 306 may bifurcate the single air conduit from air pump 202 into two air conduits, one connecting to the solid collection vessel 206 and one connecting to the liquid collection vessel 406. The multiplexing manifold 306 may operate to route airflow through either solid collection vessel 206 or liquid collection vessel 406, responsive to commands from client computing device 102. The air pump 202 may vent environmental air through an exhaust in the casing of control unit 118.

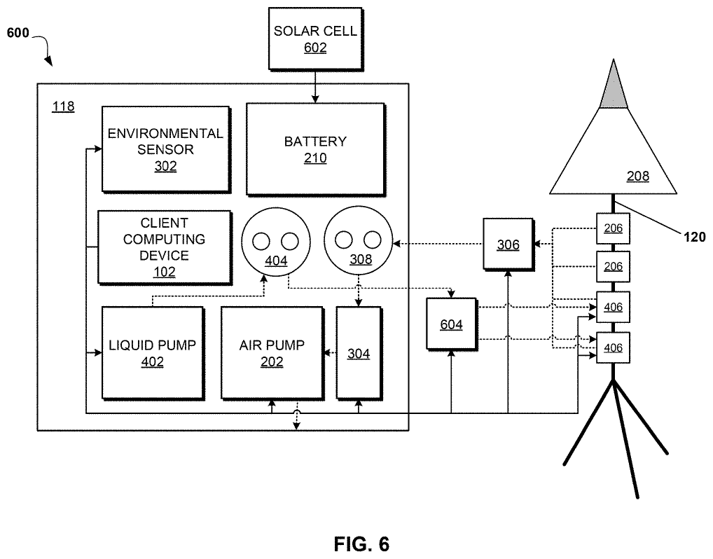

Referring now to FIG. 6, an exemplary aerosol sampling system 600 is depicted according to at least one embodiment. Here, control unit 118 comprises a client computing device 102 which is electrically and operatively connected to an air pump 202, an environmental sensor 302, a rotameter 304, a liquid pump 402, a multiplexing manifold 306, a liquid multiplexing manifold 604, and two sampler liquid level sensors within the two liquid collection vessels 406, such that the client computing device can control and/or receive sensor data from the connected components. The client computing device 102 and connected components may be connected to and powered by a battery 204, which may be connected to and receive power from a solar cell 602. The sample collector 120 may comprise two solid collection vessels 206, two liquid collection vessels 406, and a sun-shade 208 which may serve to protect the liquid collection vessels 406 from rain and from evaporation of sampler liquid by the sun and heat. The liquid pump 402 may be connected to a sampler liquid reservoir 404, which may be connected to liquid collection vessels 406. The liquid pump 402 may operate to pump sampler liquid from sampler liquid reservoir 404 through a liquid conduit and liquid multiplexing manifold 604 into liquid collection vessels 406, responsive to commands from client computing device 102. The liquid multiplexing manifold 604 may bifurcate the single liquid conduit from liquid pump 402 into two liquid conduits, each connecting to one of the two liquid collection vessels 406. The liquid multiplexing manifold 604 may operate to route sampler liquid through either of the two liquid collection vessels 406, responsive to commands from client computing device 102. The air pump 202 may be connected to the solid collection vessels 206 and the liquid collection vessels 406 via air conduits and the multiplexing manifold 306, through which the air pump 202 may draw air from the environment into and through the solid collection vessels 206 or the liquid collection vessels 406 so as to build up a critical density of aerosolized particles within the selected collection vessel. Attached to the air conduit connecting the solid collection vessels 206 and the liquid collection vessels 406 to the air pump 202 is a water trap 308. The multiplexing manifold 306 may bifurcate the single air conduit from air pump 202 into four air conduits, two connecting to the two solid collection vessels 206 and two connecting to the two liquid collection vessels 406. The multiplexing manifold 306 may operate to route airflow through one of the two solid collection vessels 206 or one of the two liquid collection vessels 406, responsive to commands from client computing device 102. The air pump 202 may vent environmental air through an exhaust in the casing of control unit 118.

Referring now to FIG. 7, an exemplary aerosol sampling system 700 is depicted according to at least one embodiment. Here, control unit 118 comprises a client computing device 102 which is electrically and operatively connected to an air pump 202, an environmental sensor 302, a rotameter 304, a liquid pump 402, a multiplexing manifold 306, a liquid multiplexing manifold 604, and two sampler liquid level sensors within the two liquid collection vessels 406, such that the client computing device can control and/or receive sensor data from the connected components. The client computing device 102 and connected components may be connected to and powered by a battery 204, which may be connected to and receive power from a solar cell 602. The sample collector 120 may comprise two solid collection vessels 206, two liquid collection vessels 406, and a sun-shade 208 which may serve to protect the liquid collection vessels 406 from rain and from evaporation of sampler liquid by the sun and heat. The liquid pump 402 may be connected to a sampler liquid reservoir 404, which may be connected to liquid collection vessels 406. The liquid pump 402 may operate to pump sampler liquid from sampler liquid reservoir 404 through a liquid conduit and combined multiplexing manifold 702 into liquid collection vessels 406, responsive to commands from client computing device 102. The combined multiplexing manifold 702 may bifurcate the single liquid conduit from liquid pump 402 into two liquid conduits, each connecting to one of the two liquid collection vessels 406. The combined multiplexing manifold 702 may operate to route sampler liquid and airflow through either of the two liquid collection vessels 406, responsive to commands from client computing device 102. The air pump 202 may be connected to the solid collection vessels 206 and the liquid collection vessels 406 via air conduits and the combined multiplexing manifold 702, through which the air pump 202 may draw air from the environment into and through the solid collection vessels 206 or the liquid collection vessels 406 so as to build up a critical density of aerosolized particles within the selected collection vessel. Attached to the air conduit connecting the solid collection vessels 206 and the liquid collection vessels 406 to the air pump 202 is a water trap 308. The combined multiplexing manifold 702 may bifurcate the single air conduit from air pump 202 into four air conduits, two connecting to the two solid collection vessels 206 and two connecting to the two liquid collection vessels 406. The combined multiplexing manifold 702 may operate to route airflow through one of the two solid collection vessels 206 or one of the two liquid collection vessels 406, responsive to commands from client computing device 102. The air pump 202 may vent environmental air through an exhaust in the casing of control unit 118.

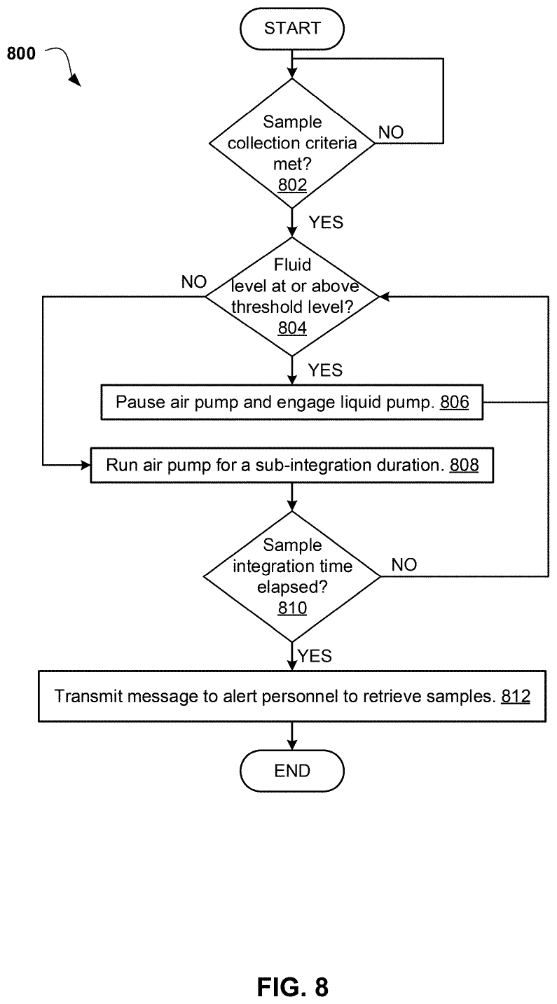

Referring now to FIG. 8, an operational flowchart illustrating an aerosol sampler process 800 is depicted according to at least one embodiment. At 802, the aerosol sampler program 110A, 110B determines whether sample collection criteria have been met. Here, aerosol sampler program 110A, 110B checks sample collection criteria for all sample collection vessels. Depending on the sample collection criteria, checking may entail comparing remote data or data from environmental sensors 302 against a threshold number comprising the sample collection criteria, such as humidity, temperature, air quality, time of day, et cetera. Checking may entail determining whether an external command to commence collection of the sample has been received. According to one implementation, if the aerosol sampler program 110A, 110B determines that no sample collection criteria have been met (step 802, “NO” branch), the aerosol sampler program 110A, 110B may continue to step 802 to determine whether sample collection criteria have been met. If the aerosol sampler program 110A, 110B determines that a sample collection criteria for a sample collection vessel 218 have been met (step 802, “YES” branch), the aerosol sampler program 110A, 110B may continue to step 804 to determine whether the fluid levels are low. In some embodiments of the invention, for example where the system comprises multiple collection vessels, aerosol sampler program 110A, 110B may iterate through the sample collection criteria for the collection vessels one at a time and proceed to the next step of the method 800 upon determining that sample collection criteria has been met for a sample collection vessel. When the sample for that sample collection vessel has been collected, the aerosol sampler program 110A, 110B may start the method 800 anew.

At 804, the aerosol sampler program 110A, 110B determines whether fluid level meets or exceeds a threshold. The fluid level may be a level of sampler liquid within a liquid collection vessel. The aerosol sampler program 110A, 110B may determine the level of the sampler liquid within the liquid collection vessel through a fluid level sensor integrated into the liquid collection vessel and compare the determined level of the sampler liquid against a threshold level. The threshold level may be, for example, the recommended fill limit of the liquid collection vessel, and/or the level of sampler liquid below which efficiency of the liquid collection vessel is negatively affected. According to one implementation, if the aerosol sampler program 110A, 110B determines that fluid level is below the threshold level (step 804, “YES” branch), the aerosol sampler program 110A, 110B may continue to step 806 to pause the air pump and engage the fluid pump. If the aerosol sampler program 110A, 110B determines that sampler liquid levels are at or above the threshold level (step 804, “NO” branch), the aerosol sampler program 110A, 110B may continue to step 808 to run the air pump for a sub-integration duration.

t 806, the aerosol sampler program 110A, 110B pauses the air pump and engages the fluid pump. Here, the aerosol sampler program 110A, 110B ceases operation of the air pump 202 and activates liquid pump 402. In some embodiments of the invention, for example where the system comprises multiple liquid collection vessels, aerosol sampler program 110A, 110B may operate the liquid multiplexing manifold 604 or combined multiplexing manifold 702 to route sampler liquid from reservoir 404 to the liquid collection vessel 406 to which the previously met selection criteria corresponds. If the air pump 202 was not operating, for example in scenarios where the sampler liquid level is below the threshold prior to the activation of the air pump 202, aerosol sampler program 110A, 110B does not pause the air pump 202. In some embodiments of the invention, aerosol sampler program 110A, 110B may operate the liquid pump 402 for a predetermined increment of time, and/or may determine and run liquid pump 402 for an amount of time necessary, based on the reported and threshold sampler liquid levels, to fill the sample collection vessel 406 to the threshold level.

At 808, the aerosol sampler program 110A, 110B runs the air pump for a sub-integration duration. Here, aerosol sampler program 110A, 110B activates the air pump 202 for a sub-integration duration, which may be a period of time that is less than the sample integration time. The sample integration time may represent the amount of time the air pump 202 must be run in order to achieve a sample of sufficient density as to be measurable by appropriate on-site laboratory analysis. In some embodiments of the invention, the sub-integration duration may be a fraction of the sample integration time. In some embodiments of the invention, the aerosol sampler program 110A, 110B may terminate operation of the air pump 202 when the sample integration time has elapsed, even if the sub-integration duration has not elapsed.

At 810, the aerosol sampler program 110A, 110B determines whether the sample integration time has elapsed. According to one implementation, if the aerosol sampler program 110A, 110B determines that the sample integration time has not elapsed (step 810, “NO” branch), the aerosol sampler program 110A, 110B may continue to step 804 to determine whether the fluid level is low. If the aerosol sampler program 110A, 110B determines that the sample integration time has elapsed (step 810, “YES” branch), the aerosol sampler program 110A, 110B may continue to step 812 to transmit a message to alert personnel to retrieve samples.

At 812, the aerosol sampler program 110A, 110B transmits a message to alert personnel to retrieve samples. The aerosol sampler program 110A, 110B may transmit a message directly to mobile devices associated with personnel/users of the system, and/or may update a database, webpage, online repository, et cetera to reflect that a sample was collected, and in embodiments where the sample collector 120 comprises multiple sample collection vessels, may specify the sample collected and/or the sample collection criteria that was met. In some embodiments of the invention, for example where the sample collector 120 comprises multiple sample collection vessels, the aerosol sampler program 110A, 110B may transmit a message only when all or a subset of samples have been collected.

It may be appreciated that FIGS. 2-8 provide only illustrations of individual implementations and do not imply any limitations with regard to how different embodiments may be implemented. Many modifications to the depicted environments may be made based on design and implementation requirements.

FIG. 9 is a block diagram 900 of internal and external components of the client computing device 102 and the server 112 depicted in FIG. 1 in accordance with an embodiment of the present invention. It should be appreciated that FIG. 9 provides only an illustration of one implementation and does not imply any limitations with regard to the environments in which different embodiments may be implemented. Many modifications to the depicted environments may be made based on design and implementation requirements.

The data processing system 902, 904 is representative of any electronic device capable of executing machine-readable program instructions. The data processing system 902, 904 may be representative of a smart phone, a computer system, PDA, or other electronic devices. Examples of computing systems, environments, and/or configurations that may represented by the data processing system 902, 904 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 902a,b and external components 904a,b illustrated in FIG. 9. Each of the sets of internal components 902 include one or more processors 920, one or more computer-readable RAMs 922, and one or more computer-readable ROMs 924 on one or more buses 926, and one or more operating systems 928 and one or more computer-readable tangible storage devices 930. The one or more operating systems 928, the aerosol sampler program 110A in the client computing device 102, and the aerosol sampler program 110B in the server 112 are stored on one or more of the respective computer-readable tangible storage devices 930 for execution by one or more of the respective processors 920 via one or more of the respective RAMs 922 (which typically include cache memory). In the embodiment illustrated in FIG. 9, each of the computer-readable tangible storage devices 930 is a magnetic disk storage device of an internal hard drive. Alternatively, each of the computer-readable tangible storage devices 930 is a semiconductor storage device such as ROM 924, EPROM, flash memory or any other computer-readable tangible storage device that can store a computer program and digital information.

Each set of internal components 902a,b also includes a RAY drive or interface 932 to read from and write to one or more portable computer-readable tangible storage devices 938 such as a CD-ROM, DVD, memory stick, magnetic tape, magnetic disk, optical disk or semiconductor storage device. A software program, such as the aerosol sampler program 110A, 110B, can be stored on one or more of the respective portable computer-readable tangible storage devices 938, read via the respective RAY drive or interface 932, and loaded into the respective hard drive 930.

Each set of internal components 902a,b also includes network adapters or interfaces 936 such as a TCP/IP adapter cards, wireless Wi-Fi interface cards, or 3G or 4G wireless interface cards or other wired or wireless communication links. The aerosol sampler program 110A in the client computing device 102 and the aerosol sampler program 110B in the server 112 can be downloaded to the client computing device 102 and the server 112 from an external computer via a network (for example, the Internet, a local area network or other, wide area network) and respective network adapters or interfaces 936. From the network adapters or interfaces 936, the aerosol sampler program 110A in the client computing device 102 and the aerosol sampler program 110B in the server 112 are loaded into the respective hard drive 930. The network may comprise copper wires, optical fibers, wireless transmission, routers, firewalls, switches, gateway computers and/or edge servers.

Each of the sets of external components 904a,b can include a computer display monitor 944, a keyboard 942, and a computer mouse 934. External components 904a,b can also include touch screens, virtual keyboards, touch pads, pointing devices, and other human interface devices. Each of the sets of internal components 902a,b also includes device drivers 940 to interface to computer display monitor 944, keyboard 942, and computer mouse 934. The device drivers 940, R/W drive or interface 932, and network adapter or interface 936 comprise hardware and software (stored in storage device 930 and/or ROM 924).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

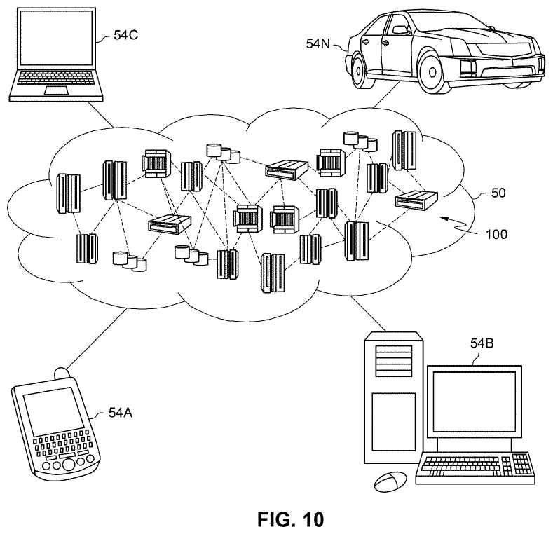

Referring now to FIG. 10, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 10 are intended to be illustrative only and that computing nodes 100 and cloud computing environment 50 can communicate with any type of computerized device over any type of network and/or network addressable connection (e.g., using a web browser).

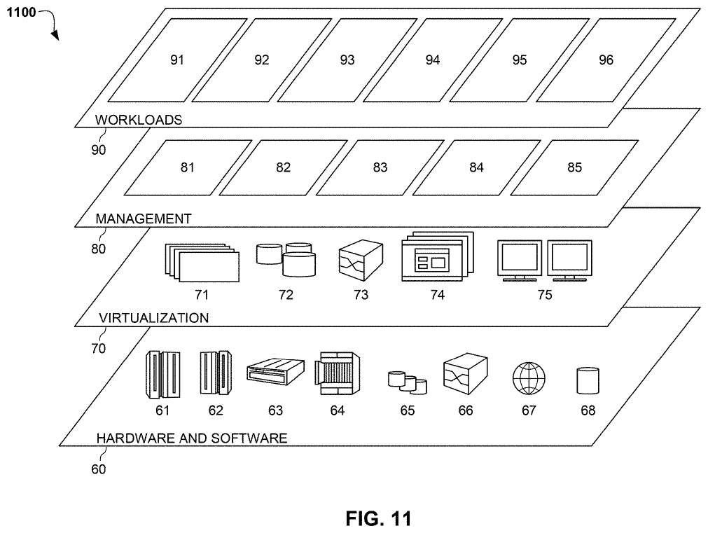

Referring now to FIG. 11, a set of functional abstraction layers 1100 provided by cloud computing environment 50 is shown. It should be understood in advance that the components, layers, and functions shown in FIG. 11 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and aerosol sampler 96. The aerosol sampler 96 may be enabled to collect and store aerosol samples for future analysis over a long period based on onboard decision-making using real-time sensor data.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for collecting aerosol samples, the method comprising:
responsive to one or more sample collection criteria being met, collecting an aerosol sample in at least one of one or more collection media, wherein collecting the aerosol sample comprises propelling air, via an air pump, through a collection medium of the one or more collection media for a duration equal to a sample integration time; and
transmitting a message alerting one or more users that the aerosol sample has been collected.

2. The method of claim 1, wherein at least one of the one or more collection media are liquid collection media.

3. The method of claim 2, further comprising:
responsive to detecting that a sampler liquid level in at least one liquid collection medium is below a threshold, raising the sampler liquid level in the at least one liquid collection medium to meet the threshold.

4. The method of claim 3, wherein collecting the aerosol sample further comprises:
responsive to a sub-integration duration elapsing, detecting whether a sampler liquid level in at least one liquid collection medium is below a threshold, wherein the sub-integration duration is less than the sample integration time.

5. The method of claim 1, wherein the sample collection criteria comprise one or more critera selected from a list consisting of: real-time environmental sensor data, remote command, and one or more pre-programmed routines.

6. The method of claim 1, further comprising:
selecting a collection medium of a plurality of collection media to collect an aerosol sample in based on the sample collection criteria.

7. The method of claim 6, wherein collecting the aerosol sample further comprises:
routing air to the selected collection media of the plurality of collection media via a multiplexing manifold.

8. A computer system for collecting aerosol samples, the computer system comprising:
one or more control units, one or more sample collectors, one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
responsive to one or more sample collection criteria being met, collecting an aerosol sample in at least one of one or more collection media, wherein collecting the aerosol sample comprises propelling air, via an air pump, through a collection medium of the one or more collection media for a duration equal to a sample integration time; and
transmitting a message alerting one or more users that the aerosol sample has been collected.

9. The computer system of claim 8, wherein at least one of the one or more collection media are liquid collection media.

10. The computer system of claim 9, further comprising: responsive to detecting that a sampler liquid level in at least one liquid collection medium is below a threshold, raising the sampler liquid level in the at least one liquid collection medium to meet the threshold.

11. The computer system of claim 10, wherein collecting the aerosol sample further comprises:
responsive to a sub-integration duration elapsing, detecting whether a sampler liquid level in at least one liquid collection medium is below a threshold, wherein the sub-integration duration is less than the sample integration time.

12. The computer system of claim 11, wherein the sub-integration duration is based on an evaporation rate affecting the sampler liquid level.

13. The method of claim 8, further comprising:
selecting a collection medium of a plurality of collection media to collect an aerosol sample in based on the sample collection criteria.

14. The method of claim 13, wherein collecting the aerosol sample further comprises:
routing air to the selected collection media of the plurality of collection media via a multiplexing manifold.

15. A computer program product for collecting aerosol samples, the computer program product comprising:
one or more computer-readable tangible storage medium and program instructions stored on at least one of the one or more tangible storage medium, the program instructions executable by a processor to cause the processor to perform a method comprising:
responsive to one or more sample collection criteria being met, collecting an aerosol sample in at least one of one or more collection media, wherein collecting the aerosol sample comprises propelling air, via an air pump, through a collection medium of the one or more collection media for a duration equal to a sample integration time; and
transmitting a message alerting one or more users that the aerosol sample has been collected.

16. The computer program product of claim 15, wherein at least one of the one or more collection media are liquid collection media.

17. The computer program product of claim 16, further comprising:
responsive to detecting that a sampler liquid level in at least one liquid collection medium is below a threshold, raising the sampler liquid level in the at least one liquid collection medium to meet the threshold.

18. The computer program product of claim 17, wherein collecting the aerosol sample further comprises:
responsive to a sub-integration duration elapsing, detecting whether a sampler liquid level in at least one liquid collection medium is below a threshold, wherein the sub-integration duration is less than the sample integration time.

19. The computer program product of claim 17, wherein raising the sampler liquid level further comprises:
routing sampler liquid to the liquid collection medium of the plurality of collection media with a liquid multiplexing manifold.

20. A computer system for collecting aerosol samples, the computer system comprising:
a control unit comprising one or more processors, one or more computer-readable memories, one or more computer-readable tangible storage media, an air pump, a battery, and one or more environmental sensors; and
a sample collection unit comprising a collection medium, wherein the sample collection unit is connected to the control unit via at least one fluid conduit.

21. The computer system of claim 20, wherein the control unit further comprises one or more solar cells.

22. The computer system of claim 20, wherein the control unit further comprises one or more wireless communications devices.

23. The computer system of claim 20, wherein the sample collector comprises a plurality of collection media and a plurality of fluid conduits, and where the control unit further comprises a multiplexing manifold comprising a valve for routing fluid through the plurality of fluid conduits to the plurality of collection media.

24. A computer system for collecting aerosol samples, the computer system comprising:
a control unit comprising one or more processors, one or more computer-readable memories, one or more computer-readable tangible storage media, an air pump, a liquid pump, a sampler liquid reservoir, a battery, and one or more environmental sensors; and
a sample collection unit comprising a liquid collection medium, wherein the sample collection unit is connected to the air pump and the liquid pump of the control unit via at least one fluid conduit.

25. The computer system of claim 24, wherein the sample collector comprises a plurality of liquid collection media and a plurality of fluid conduits, and where the control unit further comprises a multiplexing manifold comprising a valve for routing sampler liquid and air through the plurality of fluid conduits to the plurality of liquid collection media.
